(19) United States
(12) Patent Application Publication
(10) Pub. No.: US 2009/0240881 A1
(43) Pub. Date: Sep. 24, 2009

(54) System and Method for Information Handling System Operation With Different Types of Permanent Storage Devices

(76) Inventors: Munif Farhan Halloush, Round Rock, TX (US); Thomas L. Pratt, Austin, TX (US); Anthony Wright, Austin, TX (US); Martin R. Stevens, Austin, TX (US)

Correspondence Address: HAMILTON & TERRILE, LLP, P.O. BOX 203518, AUSTIN, TX, 78720, US

(21) Appl. No.: 12/053,688

(22) Filed: Mar. 24, 2008

(51) Int. Cl. G06F 12/00

(52) U.S. Cl. 711/114; 711/E12.001

(57) ABSTRACT

A storage controller, such as a RAID controller arbitrates storage tasks between a hard disk drive and a solid state drive based on predetermined factors, such as the type of information associated with a read or a write or the power available for running the storage devices. For example, a RAID controller on a portable information handling system performs writes and reads for sequential information with a hard disk drive. If power is limited, such as from a battery, the storage controller powers down the hard disk drive and performs storage tasks with the solid state drive with periodic power ups of the hard disk drive to mirror stored information.

### BACKGROUND OF THE INVENTION

1. Field of the Invention

The present invention relates in general to the field of information handling system storage devices, and more particularly to a system and method for an information handling system operation with different types of permanent storage devices.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems typically store information locally and remotely. Local storage generally includes permanent and non-permanent storage. For example, non-permanent storage includes random access memory (RAM) which requires power to maintain information. Permanent storage typically includes a hard disk drive (HDD) and firmware. A hard disk drive stores information on a rotating magnetic media that stores and maintains information by altering magnetic qualities of a disk. Firmware stores information in flash memory that maintains information even when power is removed. In a typical information handling system, firmware stored in flash memory includes instructions to initiate a boot of the system so that a processor can retrieve an operating system from the hard disk drive and run the operating system using the RAM to coordinate operation of the various components and applications running on the information handling system. Remote storage is typically permanent storage that is accessible to information handling systems through an external cable or a network. For example, hard disk drives are organized in JBOD or RAID configurations and accessed through a storage area network (SAN). Remote storage of information typically provides better access at an enterprise level and better security in that redundant storage is less complex from a central location.

Advances in flash memory have led to the introduction of another type of permanent storage for information handling systems, the solid state drive (SSD). SSDs are essentially HDDs that use flash memory for permanent storage instead of a magnetic disk. SSDs typically use less power than HDDs because SSDs do not rely on moving parts, such as a rotating magnetic disk. SSDs also tend to be more robust than HDDs, which are sometimes damaged by movement of the information handling system. The reduced power consumption and increased robustness of SSDs make SSDs especially attractive for portable information handling systems that rely on internal batteries and that are often subjected to external shocks. However, SSDs tend to cost more than HDDs and tend to have smaller storage capacities. HDDs also tend to outperform SSDs when writing and reading sequential data, such as video information, while SSDs outperform HDDs in retrieving randomly stored information. The differences in performance relate to differences in the operation of HDDs and SSDs. For example, HDDs locate information by placement of an arm over a rotating disk while SSDs have to erase information in storage before performing writes.

### SUMMARY OF THE INVENTION

Therefore, a need has arisen for a system and method that manages information handling system operations using different types of permanent storage devices.

In accordance with the present invention, a system and method are provided which substantially reduce the disadvantages and problems associated with previous methods and systems for managing different types of storage devices associated with an information handling system. A storage arbitrator arbitrates storage tasks associated with an information handling system between a hard disk drive and a solid state drive based on predetermined factors to achieve desired performance improvements, such as improved storage and retrieval speeds or reduced power consumption.

More specifically, an information handling system has plural processing components that cooperate to use information. A hard disk drive and a solid state drive cooperate to store and retrieve information. A storage controller, such as a RAID controller, manages the use of the storage devices, such as by keeping a mirror copy on each storage device. A storage arbitrator associated with the storage controller arbitrates storage tasks between the solid state drive and hard disk drive based on predetermined factors. For example, the storage arbitrator arbitrates storage tasks based on the type of information associated with the storage tasks. Writes and reads of sequential information, such as video, are performed with the hard disk drive while writes and reads of random non-sequential information are performed with the solid state drive. As another example, with reduced available power, such as when the information handling system runs on battery power, the storage arbitrator powers down the hard disk drive to save power and uses the solid state drive for storage tasks. The hard disk drive periodically powers up to mirror information stored on the solid state drive.

The present invention provides a number of important technical advantages. One example of an important technical advantage is that storage tasks are arbitrated between different types of storage devices to provide desired information handling system improvements. For example, write and read operations are performed more efficiently by analyzing the data involved to determine whether the data is sequential or non-sequential so that sequential information uses the hard disk drive and non-sequential information uses the solid state drive. As another example, with reduced available power, such as during battery operations, the solid state drive is used for storage tasks while the hard disk drive is powered down to reduce power consumption. The hard disk drive is periodically powered up to copy the writes performed on the solid state drive.

### BRIEF DESCRIPTION OF THE DRAWINGS

The present invention may be better understood, and its numerous objects, features, and advantages made apparent to those skilled in the art by referencing the accompanying drawings. The use of the same reference number throughout the several figures designates a like or similar element.

FIG. 1 depicts a block diagram of a portable information handling system that arbitrates storage tasks between a solid state drive and a hard disk drive;

FIG. 2 depicts a block diagram of a storage controller that arbitrates storage tasks between one or more solid state drives and one or more hard disk drives; and

FIG. 3 depicts a flow diagram of a process for arbitrating storage tasks between a solid state drive and a hard disk drive.

### DETAILED DESCRIPTION

Arbitrating storage tasks of an information handling system between a hard disk drive and a solid state drive provides improved speed for storage operations, improved security for stored information and reduced power consumption for the information handling system. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

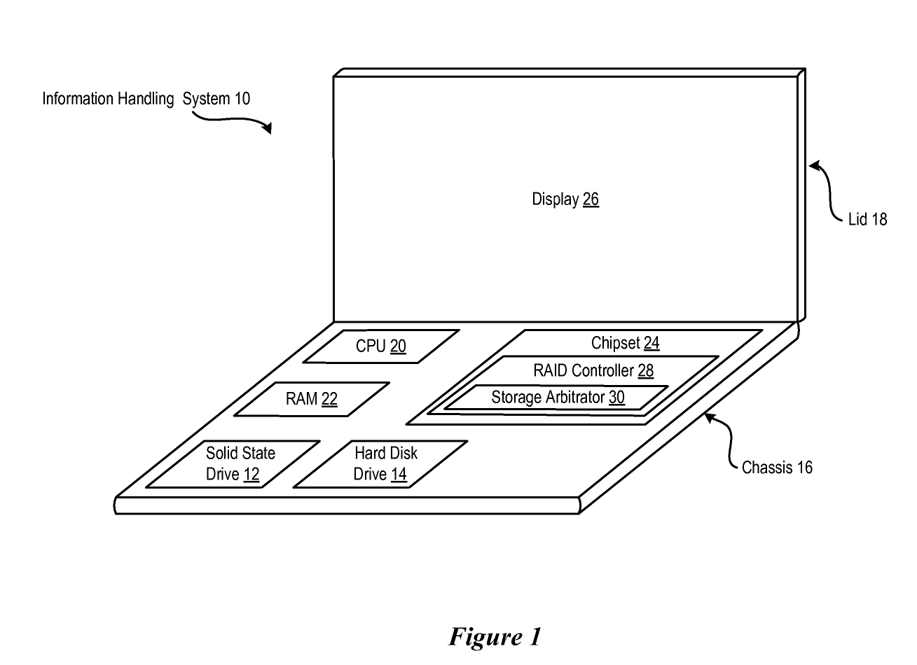

Referring now to FIG. 1, a block diagram depicts a portable information handling system 10 that arbitrates storage tasks between a solid state drive 12 and a hard disk drive 14. Solid state drive 12 performs storages tasks in much the same way as hard disk drive 14 except that solid state drive 12 has flash memory while hard disk drive 14 has a rotating magnetic disk. Portable information handling system 10 is built in a portable chassis 16 having a rotationally coupled lid 18. Processing components within chassis 16 cooperate to process information. For example, a CPU 20 runs an operating system and applications retrieved from solid state 12 and hard disk drive 14 with cooperation of RAM 22 and a chipset 24, which coordinates operation of the processing components at a physical layer. Rotationally coupled lid 18 has an integrated display 26 which presents information as visual images. Chipset 24 and an operating system running on CPU 20 cooperate to manage power consumption, such as by selectively enabling or disabling components based on whether information handling system 10 runs on internal battery power or external power provided from an AC adapter.

Chipset 24 includes a RAID controller 28 which provides information security by creating a mirror copy of stored information on both solid state drive 12 and hard disk drive 14. If, for example, solid state drive 12 has less capacity than hard disk drive 14, RAID controller 28 can mirror solid state drive 12 to a partition of hard disk drive 14, thus leaving addition partitions of hard disk drive 14 for other tasks, such as mirroring other solid state drives 12 should information handling system 10 have plural solid state drives. A storage arbitrator 30 associated with RAID controller 28 arbitrates storage tasks, such as reads, writes and mirroring operations, between solid state drive 12 and hard disk drive 14 based on one or more predetermined factors. For example, storage arbitrator 30 arbitrates storage tasks based on an analysis of the type of information involved in the storage task, the available power to perform the storage task and information security constraints. Where analysis of information involved in a read or write indicates an efficiency associated with a storage device, storage arbitrator 30 performs the storage task with the more efficient device. For instance, sequential information is read or written with hard disk drive 14 while non-sequential or random information is read or written with solid state drive 12. In alternative embodiments, a solid state drive might handle sequential information more efficiently while a hard disk drive might handle non-sequential information more efficiently; the present disclosure assigns storage duties based on the characteristics of the storage devices for a given system. As another example, the solid state drive is used for frequently accessed information, such as the operating system and applications, while the hard disk drive is used for less-frequently accessed information, such as inactive documents or backed up information. Where power is limited, such as during battery powered operations, storage arbitrator 30 performs storage tasks so as to reduce power consumption. For example, hard disk drive 14 is powered down to take advantage of reduced power consumption by solid state drive 12. Periodic powering up of hard disk drive 14 allows mirroring of information as desired for improved information security.

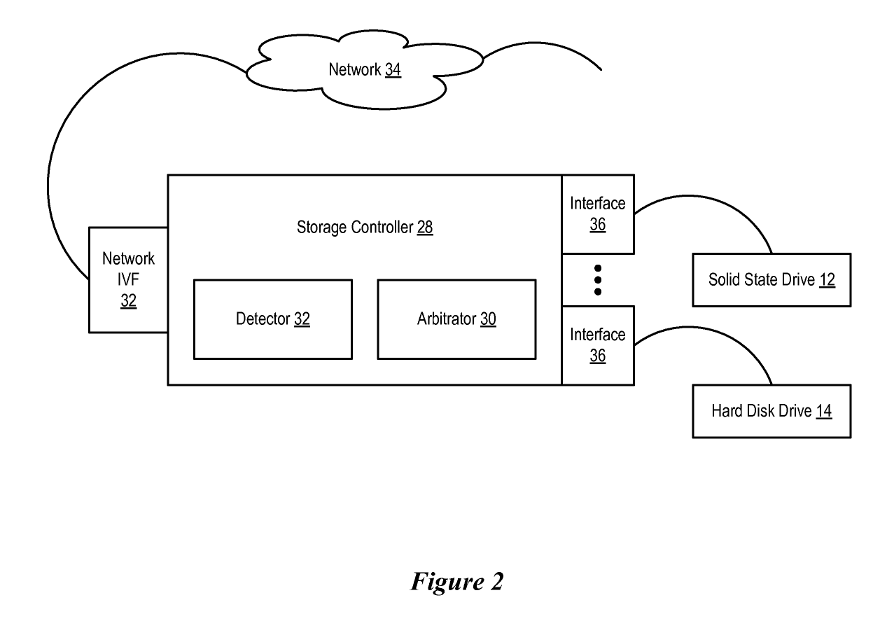

Referring now to FIG. 2, a block diagram depicts a storage controller 28 that arbitrates storage tasks between one or more solid state drives 12 and one or more hard disk drives 14. For example, storage controller 28 has a network interface to support communications over a network 34, such as a storage area network (SAN). Solid state drives 12 and hard disk drives 14 communicated through storage device interfaces 36 to accept storage tasks as assigned by storage arbitrator 30. A detector 32 determines the type of storage device coupled to each interface 36 so that arbitrator 30 assigns storage tasks to each type of storage device based on predetermined factors. For example, frequently accessed information is stored in solid state drives 12 which remain powered on while less-frequently accessed information is stored in hard disk drives 14, which may be powered down to reduce power consumption.

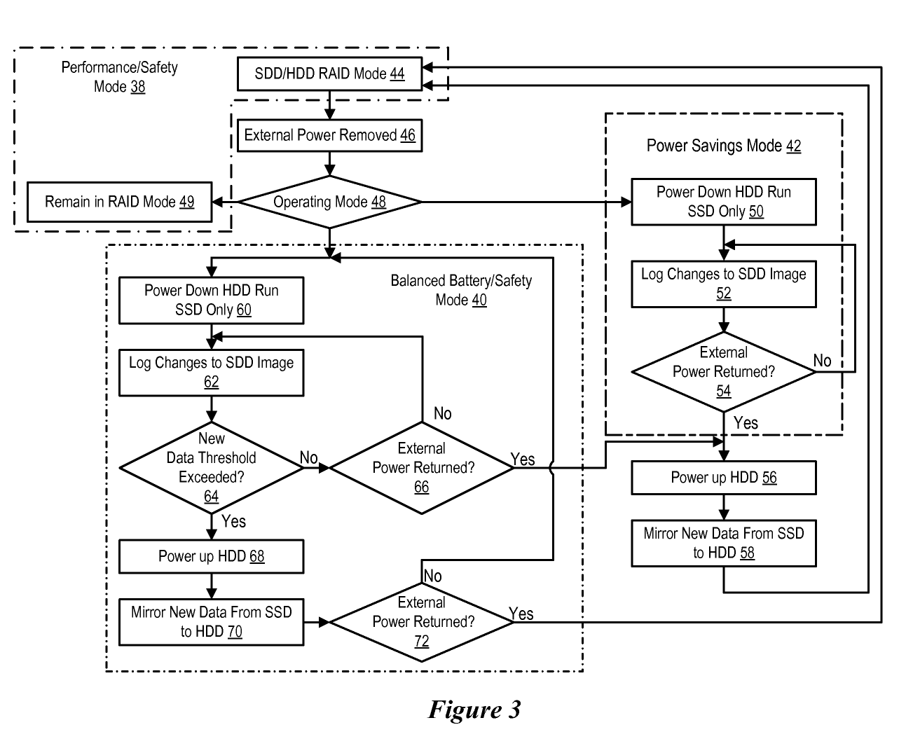

Referring now to FIG. 3, a flow diagram depicts a process for arbitrating storage tasks between a solid state drive and a hard disk drive. Storage devices transition between a performance mode 38, a balanced mode 40 and a power savings mode 42. The process starts at step 44 with initiation of a solid state drive and a hard disk drive in a RAID configuration. At step 46, power is limited, such as by removal of external power from a portable information handling system. At step 48, a determination is made of the type of operating mode that is selected. If a performance mode is selected to provide maximized information security, the process continues to step 49 to have both storage devices remain powered up and in the RAID configuration. If at step 48 a power savings mode is determined, the process continues to step 50 to power down the hard disk drive so that only the solid state drive runs. At step 52, a log is made of changes to the solid state drive image. At step 54, a determination is made of whether external power has returned. If not, the process returns to step 52 to continue logging changes made to the solid state drive. If at step 54 external power returns, the process continues to step 56 to power up the hard disk drive and to step 58 to mirror new data from the solid state drive to the hard disk drive based on the log.

If at step 48, a balance mode of operation is selected, the process continues to step 60 to power down the hard disk drive and run only the solid state drive. At step 62, changes made to the solid state are logged. At step 64, a determination is made of whether a data threshold is exceeded, such as greater than a predetermined number of writes to the solid state drive. If no, the process continues to step 66 to determine if external power is returned. If external power is not returned, the process continues to step 62 to continue to log changes made to the solid state drive. If external power is returned, the process continues to step 56. If at step 64 the data threshold is exceeded, the process continues to step 68 to power up the hard disk drive. At step 70, the new data written to the solid state drive is mirrored to the hard disk drive with the log. At step 72, a determination is made of whether external power is returned. If external power is not returned, the process continues to step 60 to keep the HDD powered down and run with only the SSD. If external power is returned, the process continues to step 44.

Although the present invention has been described in detail, it should be understood that various changes, substitutions, and alterations can be made hereto without departing from the spirit and scope of the invention as defined by the appended claims.

What is claimed is:

1. An information handling system comprising:
a processor operable to process information and to generate a storage task;
a hard disk drive interfaced with the processor, the hard disk drive operable to store information on a rotating magnetic disk and to perform the storage task;
a solid state drive interfaced with the processor, the solid state drive operable to store information in flash memory and to perform the storage task; and
a storage arbitrator interfaced with the hard disk drive and the solid state drive, the storage arbitrator operable to select one of the hard disk drive or the solid state drive to perform a predetermined task based on one or more factors.

2. The information handling system of claim 1 further comprising a RAID controller interfaced with the hard disk drive and the solid state drive, the RAID controller operable to mirror information stored on the hard disk drive and the solid state drive.

3. The information handling system of claim 2 further comprising plural solid state drives and plural partitions in the hard disk drive, the RAID controller operable to mirror each of the solid state drives on a partition of the hard disk drive.

4. The information handling system of claim 2 wherein the predetermined task comprises a read of information and the factors comprise sequential storage of the information, the storage arbiter selecting the hard disk drive to read the information.

5. The information handling system of claim 2 wherein the predetermined task comprises a read of information and the factors comprise random storage of the information, the storage arbiter selecting the solid state drive to read the information.

6. The information handling system of claim 2 wherein the predetermined task comprises a write of information and the factors comprise sequential storage of the information, the storage arbiter selecting the hard disk drive to write the information.

7. The information handling system of claim 2 wherein the predetermined task comprises a write of information and the factors comprise random storage of the information, the storage arbiter selecting the solid state drive to write the information.

8. The information handling system of claim 7 wherein the predetermined task comprises a write of information and the factors comprise limited available power, the storage arbiter selecting the solid state drive to write the information and powering down the hard disk drive.

9. The information handling system of claim 7 wherein the predetermined task comprises a read of information and the factors comprise limited available power, the storage arbiter selecting the solid state drive to read the information and powering down the hard disk drive.

10. The information handling system of claim 7 wherein the limited available power comprises battery power.

11. The information handling system of claim 7 wherein the storage arbiter is further operable to periodically power up the hard disk drive to mirror onto the hard disk drive writes made to the solid state drive.

12. A method for storing information, the method comprising:
generating a storage task;
analyzing the storage task based on one more predetermined factors to determine whether to do the storage task with a hard disk drive or a solid state drive; and
performing the storage task with the determined of the hard disk drive or the solid state drive.

13. The method of claim 12 wherein the storage task comprises a write, the predetermined factors comprise sequential information to write and performing the storage task further comprises writing the sequential information to the hard disk drive.

14. The method of claim 12 wherein the storage task comprises a read, the predetermined factors comprise non-sequential information and performing the storage task further comprises reading the non-sequential information from the solid state drive.

15. The method of claim 12 wherein the predetermined factors comprise power consumption and performing the storage task further comprises performing writes to the solid state drive, the method further comprising powering down the hard disk drive.

16. The method of claim 15 further comprising:
periodically powering up the hard disk drive; and
copying the writes to the hard disk drive.

17. The method of claim 16 wherein the power consumption comprises power provided from a portable information handling system battery.

18. The method of claim 12 wherein the storage task comprises a write through a RAID controller, the performing the storage task comprises writing to the solid state drive, the method further comprising mirroring the write to the hard disk drive as a subsequent background task.

19. The method of claim 12 wherein the storage task comprises a write through a RAID controller, the performing the storage task comprises writing to the hard disk drive, the method further comprising mirroring the write to the solid state disk drive as a subsequent background task.

20. A storage controller comprising:
interfaces to plural storage devices;
a detector operable to determine at least one hard disk drive and one solid state drive in communication with the interfaces; and
a storage arbitrator operable to select one of the hard disk drive or the solid state drive to perform a predetermined storage task based on one or more factors.

21. The storage controller of claim 20 wherein the one or more factors comprise whether information to write has sequential characteristics.

22. The storage controller of claim 20 wherein the one or more factors comprise whether information to read has sequential characteristics.

23. The storage controller of claim 20 wherein the one or more factors comprise power available to run the hard disk drive and solid state drive.

24. The storage controller of claim 20 wherein the one or more factors comprise a predetermined time period between writes to the hard disk drive.
